(19) United States
(12) Patent Application Publication
(10) Pub. No.: US 2024/0180196 A1
(43) Pub. Date: Jun. 6, 2024

(54) EXTRUSION COOKED LEGUME PROTEIN COMPOSITION, USES AND METHODS OF MANUFACTURE

(71) Applicant: CORN PRODUCTS DEVELOPMENT, INC., WESTCHESTER, IL (US)

(72) Inventors: Akshay ARORA, Bridgewater, NJ (US); Laura GRAHAM, Bridgewater, NJ (US); Roxanna SHARIFF, Bridgewater, NJ (US); Marjorie WELCHOFF, Bridgewater, NJ (US); Catherine BOMONT, Bridgewater, NJ (US); Alessa SNYDER, Bridgewater, NJ (US); Ying BIAN, Bridgewater, NJ (US); Albert TILLET, Bridgewater, NJ (US); Shady MASSOUD, Bridgewater, NJ (US); Mark PANCZYK, Bridgewater, NJ (US)

(21) Appl. No.: 18/549,977

(22) PCT Filed: Mar. 11, 2022
(86) PCT No.: PCT/US2022/019906

§ 371 Date: Sep. 11, 2023

Related U.S. Application Data
(60) Provisional application No. 63/160,088, filed on Mar. 12, 2021.

(51) Int. Cl. A23J 3/26; A23J 3/14; A23J 3/22

(52) U.S. Cl. CPC A23J 3/26; A23J 3/14; A23J 3/227

(57) ABSTRACT

This specification discloses extrusion cooked vegetable protein compositions made from a mixture of legume proteins. The proteins come from the same type of legume but are processed differently. The extrusion cooked vegetable protein composition hydrates rapidly and at ambient conditions while maintaining firmness. This specification discloses a legume protein mixture useful as a feedstock for making an extrusion cooked vegetable protein compositions of the type described in this specification. This specification discloses extruder conditions for using a legume protein mixture feedstock to make an extrusion cooked vegetable protein compositions of the type described in this specification.

The technology disclosed in this specification pertains to an extrusion cooked vegetable protein composition comprising, as a source material, legume proteins obtained using different treatment processes. The extrusion-cooked vegetable protein compositions have good firmness, water holding capacity and that hydrate rapidly under ambient conditions.

Vegetable proteins lack the striation of meat proteins and so, in native form, make textural different compositions than meat. A method commonly used to try to make more meat-like vegetable composition is extrusion cooking. Extrusion cooking means cooking using an extruder, where an extruder is a machine comprising a screw-like shaft within a segmented hollow cylinder. The shaft may itself be segmented and is used to propel a feedstock through the length of the cylinder. The segments of the cylinder and shaft can be configured to supply controllably any of moisture to the feedstock, heat the feedstock, and shear the feedstock. Through extrusion cooking, vegetable proteins can be cooked and denatured and make compositions that resemble ground meat. The product, sometimes called textured vegetable protein or structured vegetable protein, has historically been made using soy protein or wheat gluten.

Legume proteins including pea proteins and fava bean proteins, have also been evaluated for making meat-like extrusion cooked vegetable protein compositions. But legumes are different than soy and wheat gluten and work is ongoing to develop legume feed stocks to make extrusion cooked vegetable protein compositions that are suitable replacements for currently available soy based or wheat gluten-based products.

In one aspect the technology disclosed in this specification pertains to an extrusion cooked vegetable protein composition made from a mixture of legume proteins. The proteins come from the same type of legume but are processed differently. The extrusion cooked vegetable protein composition hydrates rapidly at ambient conditions while maintaining firmness. In another aspect this specification discloses a legume protein mixture useful as a feedstock for making an extrusion cooked vegetable protein compositions of the type described in this specification. In another aspect this specification discloses extruder conditions for using a legume protein mixture feedstock to make an extrusion cooked vegetable protein compositions of the type described in this specification.

With reference to a first aspect, in any embodiment, this specification discloses an extrusion cooked vegetable protein composition comprising a legume protein from a single legume type in an amount of from an amount from about 60 to about 69%, or about 64% to about 69% by weight of the composition; a carbohydrate in an amount from about 3% to about 9% or from about 3% to about 6%; and, optionally, fiber in an amount from about 3% to about 9% or from about 5% to about 9% the composition having, when soaked in ambient temperature water for 10 minutes or 5 minutes having: i) a water holding capacity of from about 3.0 to about 4.5 g/g and ii) a firmness of from about 3200 g and 5400 g, or from about 3500 g to about 4500 g.

In any embodiment described in this specification, an extrusion cooked composition is a pea protein or a fava bean protein. In any embodiment described in this specification, an extrusion cooked composition is preferably a pea protein. In any embodiment of an extrusion cooked composition described in this specification the fiber and carbohydrate come from the same legume type as the protein.

During extrusion, moisture is added to the feedstock. This allows the feedstock to undergo a phase transition needed to become the extrusion cooked product. The amount of water, however, is limited and in any embodiment described in this specification, an extrusion cooked composition has a moisture content (w/w) less than about 10% or from about 5% to about 9% moisture. This is much drier than meat, so in use an extrusion cooked vegetable protein composition is commonly hydrated before mixing with other ingredients. The extrusion cooked vegetable protein composition disclosed in this specification hydrate quickly and sufficiently but retain a firm, meat-like texture.

In any embodiment described in this specification an extrusion cooked vegetable protein composition can be hydrated by soaking in water (without mixing or agitation) for 10 minutes or for 5 minutes to hold from 300% to 450% of its weight in water (a water holding capacity of from about 3.0 to about 4.5 g/g) and have a firmness of from about 3200 g and 5400 g, or from about 3500 g to about 4500. An extrusion cooked vegetable protein composition, as described in this specification, obtains the described hydration after soaking at ambient conditions using untreated tap water or deionized water or other aqueous solution. In a useful test for measuring hydration capacity, an extrusion cooked vegetable composition is hydrated in water in a ratio of about 1-part composition to 5 parts water under ambient conditions. Here, ambient temperature is meant to cover a range of conditions that would normally be experienced at cite where an extrusion cooked vegetable composition will be used to make a food product, for example, air pressures of about 1 atmosphere and temperatures from about 10° C. to about 30° C.

In any embodiment described in this specification, an extrusion cooked composition has a bulk density of from about 100 to 260 g/L. In any embodiment described in this specification, an extrusion cooked composition has an expansion index of from about 0.79 to about 2.77. In any embodiment described in this specification, an extrusion cooked composition has a molecular weight distribution wherein at least 25% of the proteins in the composition have molecular weight of less than 10 kDa. In any embodiment described in this specification, an extrusion cooked composition has a molecular weight distribution wherein less than 30% of the composition is aggregates having a molecular weight greater than about 250 kDa.

Turning to another aspect of the technology disclosed in this specification—a legume protein mixture—in any embodiment described in this specification a legume protein mixture comprises: a first legume protein component in amount of from about 70% to about 90% by weight of the composition, or from about 75% to about 85% or from about 78% to about 82%; and a second legume protein component in an amount of from about 10% to about 30% by weight of the composition, or from about 15% to about 25%, or from about 18% to about 22% wherein the first and second legume protein components are the same legume type. In any embodiment described in this specification, a legume mixture has protein content of from about 60 to about 69%, or about 64% to about 69% by weight of the mixture. In any embodiment described in this specification, a legume mixture further comprises a carbohydrate in an amount from about 3% to about 9% or from about 3% to about 6%. In any embodiment described in this specification, a legume mixture further comprises a fiber in an amount from about 3% to about 9% or from about 5% to about 9%. In any embodiment described in this specification, the protein, carbohydrate, and, fiber in a legume protein mixture come from the same legume type.

Generally, the first and second legume protein components are powdered components obtained by milling and optionally further processing a legume flour. Methods for milling legumes to make flour are known. In examples, legumes can be dry milled (meaning milling dried legumes) or wet milled (meaning milling rehydrated legumes). Wet milled legumes may further be fermented prior to wet milling. A dry milled composition can be used as is, a wet milled composition can be dried and used as is, or the dry milled or wet milled composition can be further processed.

Protein content of the composition can be increased using any of various useful methods. One illustrative method is air classification, which uses air countercurrents to separate the protein, carbohydrate, and fiber within a flour based on differences in their physical properties. Air classification processes generally do not change structure of proteins or carbohydrate or fibers within the flour. For example protein is generally not denatured in an air classification process, and starch is not gelatinized. Additionally, air classification generally does not separate different types of protein in the composition.

Another method for increasing protein content of a composition is isoelectric point extraction, which relies on solubility differences between protein, fiber and starch to separate them. For example, protein is highly soluble at pH from about 8 to 10 but starch and fiber are not. So in an aqueous dispersion legume flour adjusted to pH of about 9, the substantial amount of protein is dissolved and is be removed as a supernatant or filtrate from the insoluble fiber and starch using filtration or centrifugation. The soluble legume protein is then recovered by adjusting the pH of the solution to the protein's isoelectric point, generally around pH 4.5, where protein is highly insoluble. A second centrifugation step allows for the protein to be recovered as a precipitate.

Isoelectric point separation and air classification make different legume protein compositions. One difference is that isoelectric point separation is better at isolating the protein from a carbohydrates and starch. Another difference is degree of denaturation of the protein. Another difference is that not all protein will precipitate from solution during isoelectric point separation and some portion of the protein will remain dissolved and be lost. Smaller proteins, by molecular weight, are more likely to remain dissolved and lost. Air classification, which does not dissolve protein, therefore, will have a more complete set of proteins (relative to the natural protein content of the legume, and as measurable by molecular weight distribution) than proteins obtain using an isoelectric point separation.

With reference to a first legume protein component of legume protein mixture, in any embodiment described in this specification, the first legume protein component is an isolated legume protein. In any embodiment described in this specification, a first legume protein component of a legume protein mixture has a protein content in an amount of at least 75% (wt. %), or 75% to about 95% (w/w) of the component. In any embodiment described in this specification, a first legume protein component of a legume protein mixture has denaturation enthalpy of less than about 4 J/g or less than about 1 J/g. In any embodiment described in this specification, a first legume protein component of a legume protein mixture consists essentially of globular or globulin-type proteins. In any embodiment described in this specification, a first legume protein component of a legume protein mixture has a molecular weight distribution which is consistent with being comprised of substantially of globular or globulin type proteins.

With reference to a second legume protein component of legume protein mixture, in any embodiment described in this specification, the second legume protein component of a legume protein mixture comprises a protein in an amount of from about 50% to less than 75% (w/w). In any embodiment the second legume protein component of a legume protein mixture comprises a carbohydrate in an amount from about 3% to about 9% or from about 3% to about 6%. In any embodiment the second legume protein component of a legume protein mixture comprises a fiber in an amount from about 3% to about 9% or from about 5% to about 9%.

In some embodiments a second legume protein component of a legume protein mixture described in tis specification, the protein is legume native protein. In some embodiments a second legume protein component described in this specification, the second component is a legume flour. In other embodiments a second legume protein component is an air classified legume protein. In any embodiment disclosed in this specification, a second legume protein component of a legume protein mixture has a denaturation enthalpy of greater than less than 9 J/g. In any embodiment disclosed in this specification, a second legume protein component of a legume protein mixture comprises essentially all the protein that are in a legume. In any embodiment disclosed in this specification, a second legume protein component of a legume protein mixture comprises essentially has a molecular weight distribution of legume protein essentially the same as the molecular weight distribution of the protein in a legume. In any embodiment disclosed in this specification, a second legume protein component of a legume protein mixture comprises starch that is not gelatinized.

In other embodiments an air classified legume protein useful as the second legume protein component is further modified to partially denature the protein. An air classified legume protein can be partially denatured by a process using controlled heat and moisture to partially denature the legume protein. An illustrative process uses a tubular thin film dryer into which the air classified legume protein and moisture can be added. The dryer includes a component that propels the protein through its length as heat, moisture and hear are added partially denaturing the protein. In embodiments moisture is added to the legume protein during the heat moisture treatment in an amount from about 10% to about 50% (w/w) by weight of the air classified legume protein. In embodiments, the heat moisture treated air classified legume protein is heated to a temperature from about 100° C. to about 250° C. In any embodiment described in this specification, a second legume protein component of a legume mixture is partially denatured to have a denaturation enthalpy of from about 5 to less than 9 J/g protein or from about 5 to about 7 J/g protein. In any embodiment disclosed in this specification, a second legume protein component of a legume protein mixture comprises protein having a molecular weight distribution consistent with the molecular weight distribution the total protein in a legume. In any embodiment disclosed in this specification, a second legume protein component of a legume protein mixture comprises starch that is gelatinized.

In any embodiment a legume protein mixture has a molecular weight distribution being the combined molecular weight distribution of the first and second legume protein components. In any embodiment a legume protein mixture has a denaturation enthalpy being the combined denaturation enthalpy of the first and second legume protein component.

The thermodynamic properties of the legume protein mixture can also be assessed with reference to onset, endpoint, and mean phase transition temperatures (Tₛ) and flow temperature (T_{f}) of the material. In any embodiment a legume protein mixture has a flow temperature (T_{f}) of from about 42° C. to about 187° C. In any embodiment a legume protein mixture has an onset temperature phase transition temperature (Tₛ) of about 15° C. to about 44° C. In any embodiment a legume protein mixture has an endpoint phase transition temperature (Tₛ) of 42° C. to 110° C. In any embodiment a legume protein mixture has a mean phase transition temperature (Tₛ) of about 31° C. to about 77° C.

In any embodiment a legume protein mixture has a compressibility of from about 30% to about 60%, measured as described in this specification. In any embodiment a legume protein mixture has a flowability index of from about 30 to about 60, measured as described in this specification.

In yet another aspect, this specification discloses a method for making an extrusion cooked vegetable protein composition. The method can be applied to any feedstock described in this specification. The method can be used to make any feedstock described in this specification. In any embodiment, this specification discloses, A method of making an extrusion cooked vegetable protein composition comprising obtaining a mixture of: (i) a first legume protein component in amount of from about 70% to about 90% by weight of the composition, or from about 75% to about 85% or from about 78% to about 82%; and (ii) a second legume protein component in an amount of from about 10% to about 30% by weight of the composition, or from about 15% to about 25%, or from about 18% to about 22%; feeding the mixture into an extruder; and extruding the mixture using the extruder wherein the first and second legume protein components are the same legume type.

In any embodiment a method for making an extrusion cooked vegetable protein composition wherein the extruding step comprises extruding the mixture using a specific mechanical energy of from about 250 to about 270 W*hr/kg. In any embodiment a method for making an extrusion cooked vegetable protein composition wherein an extruding step comprises applying to the mixture during extruding a pressure from about 40 to about 50 bar or from about 40 to about 45 bar. In any embodiment a method for making an extrusion cooked vegetable protein composition wherein an extruding step comprises operating a screw-like shaft within a segmented hollow cylinder of the extruder at a rate of from about 390 to about 410 revolutions per minute.

In another aspect, this specification discloses use of an extrusion cooked vegetable protein in a food composition. In any embodiment described in this specification a food composition comprise an extrusion cooked vegetable protein composition made according to a process as described in any foregoing claim and a second edible ingredient. Food compositions described in this specification use an extrusion cooked vegetable protein in any amount (1% to 99%). More commonly food compositions described in this specification comprise an extrusion cooked vegetable composition in an amount from 1% to about 30% or from about 10% to 30% or from about 15% to about 25% (wt. %)

Although not so limited, a common use for an extrusion cooked vegetable protein composition is to extend or replace ground meat in a food composition. In at least some embodiments a food composition described in this specification is a vegan burger patty. Food compositions may comprise water, both to hydrate the extrusion cooked vegetable protein composition and to act as a binder within the food composition. Enough water is used to hydrate the extrusion cooked vegetable protein composition and to bind the food ingredient. In any embodiment all water added to the food composition is absorbed by the ingredients used such that the mixture of ingredients does not comprise a separate aqueous phase. In any embodiment a food composition comprises water or other aqueous ingredient in a from about 10% to about 60%, or from about 30% to about 60% or from about 50% to about 60%.

Embodiments of food compositions comprise fat in an amount from about 1% to about 20% or from about 5% to about 15% or from about 10% to about 15%. Fat may be from a single source or from multiple. In food compositions using multiple fats, one fat may be liquid at room temperature, and another may be solid at room temperature, which can be mixed in equal or unequal amounts to each other. In some embodiment, a food composition comprises a vegetable oil that is liquid a room temperature, for example sunflower oil, in an amount from about 5% to a about 10% by weight of the composition. In other embodiments a food composition comprises a vegetable oil that is solid at room temperature like coconut oil in an amount from about 5% to about 10% by weight of the composition. In yet other embodiments a food composition may comprise a plating agent such as a tapioca maltodextrin to carry a vegetable oil that is liquid at room temperature. Any plating agents can be used in an amount enough to absorb the liquid fat so that the fat is provided as a powder, or enough can be used to form a paste from the liquid fat.

Other ingredients that can be used in a food composition are hydrocolloids such as gums (xanthan, guar, etc.), gum like starches (e.g. acid thinned or enzymatically digested starches that form gels) and fibers (e.g methyl cellulose, carboxy methyl cellulose, hydroxypropyl methyl cellulose). Still other ingredients include flavorings, spices, seasonings, and coloring.

The following definitions and comments are useful for interpreting this specification and understanding the technology disclosed within.

Within this specification “unhydrated” with respect to an extrusion cooked vegetable protein composition refers to the composition in low moisture form. In at least some embodiments, following extrusion an extrusion cooked vegetable protein composition has water content less that about 10% (wt. %).

Within this specification the term “carbohydrate” when used with reference to the legume protein mixtures and extrusion cooked vegetable protein compositions described in this specification, is limited to starch or from sugars and polysaccharides derived from starch.

Within this specification the term “the same legume type” refers to legumes that, within the ordinary understanding within the art, would be understood to be the same. As use dictates this may mean within the same species or subspecies. Also, a legume may be of the same type although known by different common names. As non-limiting examples, in some embodiments the first and second legume protein components are from pea (Pisum sativum). In another non-limiting example, in other embodiments the first and second legume protein components are from fava bean (Vicia faba). Within this specification the first and second legume protein components are intended to come from the same type of legume but are obtained by methods causing the first and second legume protein components to have different physical and functional properties from each other.

Within this specification, “isolated legume protein” refers to a composition of substantially pure legume protein. The composition is powdered (not extruded) and has at least 75% protein by weight of the composition. Various methods for isolating legume protein are known in the art and within this specification isolated legume protein is not limited to the method of its isolation. In at least some embodiments an isolated legume protein is isolated in a process that uses different pH at different steps of the process to isolate the protein. Processes using sequential pH adjustments tend to have three results. First, the isolated legume protein is a protein type that is not very soluble in water, like globulin protein or globular-type proteins. Second, water soluble protein tends to be lost when the insoluble protein is recovered, which can be seen using SDS-PAGE comparing isolated protein and with native legume protein. Third, the pH adjustments may denature the recovered protein as determinable by differential scanning calorimetry.

Within this specification “native legume protein” refers to legume protein in a milled composition that is not further modified, for example it is substantially not denatured, as determinable, for example, using differential scanning calorimetry. Native legume protein may exist in whole legume flour or it may exist in a protein rich legume flour, if the process used to increase relative protein content does not substantially denature the legume protein. Various methods are known in the art for obtaining native legume protein, and within this specification native legume protein can be obtained by any method. In at least some embodiments a native legume protein is obtained using air classification to obtain a protein rich legume flour (protein content between about 50% and about less than 75%). In addition to being substantially not denatured, native legume proteins comprise essentially all the protein in a legume meaning it comprises, for example, globular-type (generally water insoluble) proteins and albumin-like (generally water soluble) proteins, which can be seen using SDS-PAGE.

Reference in this specification to “partially denatured legume protein” refers to legume proteins that have lower denaturation enthalpy (as measurable using differential scanning calorimetry) than native proteins but that still have substantial denaturation enthalpy, meaning they can be denatured further. Partially denatured legume protein is obtained by applying a denaturation process to a native legume protein source, whether for example a whole legume flour or a protein rich legume flour. Although not limited by process, in at least some embodiments, a partially denatured legume protein is obtained by applying a heating an air classified protein rich legume flour in limited water so that the water used is absorbed by the protein rich flour and a slurry or dispersion of the flour is not formed. Obtained in this manner, the partially denatured legume protein still comprises essentially all the proteins within a legume.

Use of “about” to modify a number is meant to include the number recited plus or minus 10%. Where legally permissible recitation of a value in a claim means about the value. Use of about in a claim or in the specification is not intended to limit the full scope of covered equivalents.

Recitation of the indefinite article “a” or the definite article “the” is meant to mean one or more unless the context clearly dictates otherwise.

While certain embodiments have been illustrated and described, a person with ordinary skill in the art, after reading the foregoing specification, can effect changes, substitutions of equivalents and other types of alterations to the methods, and of the present technology. Each aspect and embodiment described above can also have included or incorporated therewith such variations or aspects as disclosed regarding any or all the other aspects and embodiments.

The present technology is also not to be limited in terms of the aspects described herein, which are intended as single illustrations of individual aspects of the present technology. Many modifications and variations of this present technology can be made without departing from its spirit and scope, as will be apparent to those skilled in the art. Functionally equivalent methods within the scope of the present technology, in addition to those enumerated herein, will be apparent to those skilled in the art from the foregoing descriptions. Such modifications and variations are intended to fall within the scope of the appended claims. It is to be understood that this present technology is not limited to methods, conjugates, reagents, compounds, compositions, labeled compounds or biological systems, which can, of course, vary. All methods described herein can be performed in any suitable order unless otherwise indicated herein or otherwise clearly contradicted by context. It is also to be understood that the terminology used herein is for the purpose of describing aspects only and is not intended to be limiting. Thus, it is intended that the specification be considered as exemplary only with the breadth, scope and spirit of the present technology indicated only by the appended claims, definitions therein and any equivalents thereof. No language in the specification should be construed as indicating any non-claimed element as essential.

The embodiments illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

In addition, where features or aspects of the disclosure are described in terms of Markush groups, those skilled in the art will recognize that the disclosure is also thereby described in terms of any individual member or subgroup of members of the Markush group. Each of the narrower species and subgeneric groupings falling within the generic disclosure also form part of the technology. This includes the generic description of the technology with a proviso or negative limitation removing any subject matter from the genus, regardless of whether the excised material is specifically recited herein.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member, and each separate value is incorporated into the specification as if it were individually recited herein.

The technology described in this specification can be further understood with reference to the following non-limiting aspects, which are provided for illustrative purposes and are not intended to limit the full scope of the invention.
1. An extrusion cooked vegetable protein composition comprising: a legume protein from a single legume type in an amount of from an amount from about 60 to about 69%, or about 64% to about 69% by weight of the composition; a carbohydrate in an amount from about 3% to about 9% or from about 3% to about 6%; and a fiber in an amount from about 3% to about 9% or from about 5% to about 9% the composition having, when soaked in ambient temperature deionized water for 10 minutes, or 5 minutes having: i) a water holding capacity of from about 3.0 to about 4.5 g/g and ii) a firmness or from about 3200 g and 5400 g, or from about 3500 g to about 4500 g.
2. The composition of claim 1 wherein legume protein is a pea protein or a fava bean protein, and preferably is a pea protein.
3. The composition of claim 1 or 2 further having a bulk density of from about 100 to 260 g/L.
4. The composition of any one of claims 1 to 3 being having unhydrated moisture content of less than about 10% w/w, or from about 5% to about 9%.
5. The composition of any one of claims 1 to 4 having a molecular weight distribution wherein at least 25% of the proteins in the composition have molecular weight of less than 10 kDa.
6. The composition of any one of claims 1 to 5 having a molecular weight distribution wherein less than 30% of the composition is aggregates having a molecular weight greater than about 250 kDa.
7. The composition of any one of claims 1 to 6 having an expansion index of from about 0.79 to about 2.77.
8. The composition of any one of claims 1 to 7 wherein the protein, carbohydrate and fiber are from pea.
9. The composition of any one of claims 1 to 8 wherein composition consists essential of material from pea.
10. A food composition comprising the extrusion cooked vegetable protein composition of any one of claims 1 to 9 or any one of claims 51 to 53 and a second edible ingredient.
11. A legume protein mixture comprising: a first legume protein component in amount of from about 70% to about 90% by weight of the composition, or from about 75% to about 85% or from about 78% to about 82%; and a second legume protein component in an amount of from about 10% to about 30% by weight of the composition, or from about 15% to about 25%, or from about 18% to about 22% wherein the first and second legume protein components are the same legume type.
12. The mixture of claim 11 having from about 60 to about 69%, or about 64% to about 69% by weight of the mixture.
13. The mixture of claim 11 or 12 further comprising a carbohydrate in an amount from about a carbohydrate in an amount from about 3% to about 9% or from about 3% to about 6% wherein, optionally the carbohydrate is from pea or fava bean, and is preferably from pea.
14. The mixture of any one of claims 11 to 13 further comprising fiber in an amount from about 3% to about 9% or from about 5% to about 9% wherein, optionally, the fiber is from pea or fava bean, and is preferably from pea.
15. The mixture of any one of claims 11 to 14 wherein the second legume protein component is a native legume protein component or partially denatured legume protein component.
16. The mixture of any one of claims 11 to 15 wherein the second legume protein component is a partially denatured legume protein component having a denaturation enthalpy of from about 5 to less than 9 J/g protein or from about 5 to about 7 J/g protein.
17. The mixture of any one of claims 11 to 16 wherein the second legume protein component is a native legume protein component, wherein, optionally, the native legume protein has a denaturation enthalpy of 9 J/g or more.
18. The mixture of any one of claims 11 to 17 wherein the first legume protein component is an isolated legume protein component.
19. The mixture of any one of claims 11 to 18 wherein the carbohydrate comprises a starch that is not gelatinized.
20. The mixture of any one of claims 11 to 19 wherein the carbohydrate comprises a starch that is gelatinized.
21. The mixture of any one of claims 11 to 20 wherein the first legume protein component has a denaturation enthalpy of less than 4 J/g, or less than 1 J/g.
22. The mixture of any one of claims 11 to 21 wherein the legume type is fava bean or pea, and preferably is pea.
23. The mixture of any one of claims 11 to 22 having compressibility of from about 30% to about 60%.
24. The mixture of any one of claims 11 to 23 having a flowability index of from about 30 to about 60.
25. The mixture of any one of claims 11 to 24 having a flow temperature (T_{f}) of from about 42° C. to about 187° C.
26. The mixture of any one of claims 11 to 25 having an onset phase transition temperature of (Tₛ) of about 15° C. to about 44° C.
27. The mixture of any one of claims 11 to 26 having an endpoint phase transition temperature (Tₛ) of 42° C. to 110° C.
28. The mixture of any one of claims 11 to 27 having a mean phase transition temperature (Tₛ) of about 31 to about 77.
29. Use of the mixture of any foregoing to make an extrusion cooked vegetable protein composition as described in any foregoing claim.
30. A method of making an extrusion cooked vegetable protein composition comprising obtaining a mixture of: a first legume protein component in amount of from about 70% to about 90% by weight of the composition, or from about 75% to about 85% or from about 78% to about 82%; and a second legume protein component in an amount of from about 10% to about 30% by weight of the composition, or from about 15% to about 25%, or from about 18% to about 22%; feeding the mixture into an extruder; and extruding the mixture using the extruder wherein the first and second legume protein components are the same legume type.
31. The method of claim 30 wherein the mixture has a protein content of from about 60 to about 69%, or about 64% to about 69% by weight of the mixture.
32. The method of claim 30 or 31 wherein the mixture further comprises a carbohydrate in an amount from about a carbohydrate in an amount from about 3% to about 9% or from about 3% to about 6% wherein, optionally the carbohydrate is from pea or fava bean, and is preferably from pea.
33. The method of any one of claim 30 or 32 wherein the mixture further comprises a fiber in an amount from about 3% to about 9% or from about 5% to about 9% wherein, optionally, the fiber is from pea or fava bean, and is preferably from pea.
34. The method of any one of claims 30 to 33 wherein the mixture is obtained by mixing the first and second legume protein component and wherein the first legume protein component comprises a protein in an amount of from about 75% to about 95%.
35. The method of any one of claims 30 to 34 wherein the mixture is obtained by mixing the first and second legume protein component and wherein the second legume protein component comprises a protein in an amount of from about 50% to about 75%.
36. The method of any one of claims 30 to 35 wherein the mixture is obtained by mixing the first and second legume protein component and wherein the second legume protein component further comprises a carbohydrate in an amount from about a carbohydrate in an amount from about 3% to about 9% or from about 3% to about 6% wherein, optionally the carbohydrate is from pea or fava bean, and is preferably from pea.
37. The method of claim any one of claims 30 to 36 wherein the mixture is obtained by mixing the first and second legume protein component and wherein the second legume protein component further comprises a fiber in an amount from about 3% to about 9% or from about 5% to about 9% wherein, optionally, the fiber is from pea or fava bean, and is preferably from pea.
38. The method of any one of claims 30 to 37 wherein the second legume protein component is a native legume protein component or partially denatured legume protein component.
39. The method of any one of claims 30 to 38 wherein the second legume protein component is a partially denatured legume protein having a denaturation enthalpy of from about 5 to less than 9 J/g protein or from about 5 to about 7 J/g protein.
40. The method of any one of claims 30 to 39 wherein the second legume protein component is a native legume protein component, wherein, optionally, the native legume protein has a denaturation enthalpy greater than 9 J/g.
41. The method of any one of claims 30 to 40 wherein the first legume protein component is an isolated protein.
42. The method of any one of claims 30 to 41 wherein the carbohydrate comprises a starch that is not gelatinized.
43. The method of any one of claims 30 to 42 wherein the carbohydrate comprises a starch that is gelatinized.
44. The method of any one of claims 30 to 43 wherein the first legume protein component has a denaturation enthalpy of less than about 4 J/g or less than about 1 J/g
45. The method of any one of claims 30 to 44 wherein the extruding step comprises extruding the mixture using a specific mechanical energy of from about 250 to about 270 W*hr/kg.
46. The method of any one of claims 30 to 45 wherein the extruding step comprises applying to the mixture during extruding a pressure from about 40 to about 50 bar or from about 40 to about 45 bar.
47. The method of any one of claims 30 to 46 wherein the extruding step comprises operating a screw-like shaft within a segmented hollow cylinder of the extruder at a rate of from about 390 to about 410 revolutions per minute.
48. An extrusion cooked vegetable protein composition made according to a method as described in any foregoing claim.
49. Use of an extrusion cooked vegetable protein composition made according to a process as described in any forgoing claim in a food composition comprising the extrusion cooked vegetable protein composition and second edible ingredient.
50. A food composition comprising an extrusion cooked vegetable protein composition made according to a process as described in any foregoing claim and a second edible ingredient.
51. An extrusion cooked vegetable protein composition comprising:
a. a legume protein from a single legume type in an amount of from an amount from about 60 to about 69%, or about 64% to about 69% by weight of the composition; and
b. a carbohydrate in an amount from about 3% to about 9% or from about 3% to about 6%; and
   wherein, optionally, the extursion cooked vegetable protein further comprises a fiber in an amount from about 3% to about 9% or from about 5% to about 9%.
   the composition having, when soaked in ambient temperature deionized water for 10 minutes, or 5 minutes having:
i) a water holding capacity of from about 3.0 to about 4.5 g/g; and
ii) a firmness or from about 3200 g and 5400 g, or from about 3500 g to about 4500 g. wherein, optionally the legume protein is a pea protein or a fava bean protein
   wherein optionally, the extrusion cooked vegetable protein composition is as further described in any one of claims 1 to 9.
52. An extrusion cooked vegetable protein composition comprising: the composition having, when soaked in ambient temperature deionized water for 10 minutes, or 5 minutes having:
i) a water holding capacity of from about 3.0 to about 4.5 g/g; and
ii) a firmness or from about 3200 g and 5400 g, or from about 3500 g to about 4500 g. wherein, optionally the legume protein is a pea protein or a fava bean protein
   wherein optionally, has a protein content greater than about 60% (wt. %)

The extrusion cooked vegetable protein composition of claim 52 further comprising a limitation from any one of claims 1 to 9.

The technology described in this specification can be further understood with reference to the following non-limiting examples that are provided for illustrative purposes and are not intended to limit the full scope of the invention.

### EXAMPLE 1 EXTRUSION COOKED PEA PROTEIN COMPOSITION

Extrusion cooked vegetable proteins were made from a mixture of isolated pea protein (about 75% to 80% protein content wt.%) with a native pea protein (about 50% to about 55%) to obtain a target protein content of the blend of from 55% to 85%. The obtained extrusion cooked vegetable protein compositions were from a pea protein mixture having the measured properties reported in Table 1.

TABLE 1
Feedstock for Extrusion Cooked Vegetable Protein Composition

| Property | Blend |
|---|---|
| Protein content , % | 55-84 |
| Moisture content, % | 5-9 |
| Compressibility, % | 35-60 |
| Flowability index | 46-50 |
| Flow temp, T_{f} (° C.) | 42 |
| Onset temp, Tₛ (° C.) | about 20 |
| Endpoint temp, Tₛ (° C.) | about 50 |
| Mean Tₛ (° C.) | about 36 |
| Particle size (dia), μm | less than 150 |

The feedstock was extruded to obtain extrusion cooked vegetable proteins using the following generalized process. Dry powder was blended and transferred to a feeder, which meters the dry protein powder blend into the extruder or preconditioner at a set rate. Water was added to the extruder and the water and protein powder blend were mixed and pushed through the extruder and extruded. The composition exiting the extruder was cut to the desired size and dried to specified moisture content of less than about 10% (wt.%). All extruded samples were made using the following parameters. Specific mechanical energy applied is 260 W*hr/kg. The internal pressure was 43 bar, and the internal shaft was rotated at 400 revolutions per minute.

Properties of the extrusion cooked vegetable protein compositions made using the feedstock described in Table 1 are reported in Table 2.

TABLE 2
Physical Properties of Extrusion Cooked Vegetable Protein

| Property | Blend 2 |
|---|---|
| Protein content, % | 67-69 |
| Moisture content, % | 5-9 |
| Hydrated hardness, g @5 m | 2699-5093 |
| Hydrated hardness, g @10 m | 2222-4656 |
| Bulk density, g/L | 116-374 |
| WHC, g/g | 2.8-4.2 |
| WHC, % | 227-414 |
| Expansion index | 0.79-2.77 |
| Molecular weight, <10 kDa, % | >25 |
| Molecular weight, aggregates >250 kDa, % | <30 |

### EXAMPLE 2 METHODS

Measurements taken and reported in this specification were measured as follows.

Determination of compressibility and flowability of granulated plant protein (AL-HPT-001): Compressibility and flowability were obtained using the Hosokawa micron powder system. The compressibility measurement is defined by RL Carr and is determined by the relative measurement of loose and packed bulk density. Any material having a value of more than 20% may need some external measures to prevent bridge formation whether in a hopper or a storage bin.

Determination of thermal properties of granulated plant protein: A Phase Transition Analyzer (PTA; Wenger Manufacturing, Sabetha, KS) was used to measure the phase transition temperature (Tₛ) and flow temperature (Tᵣ) with modification from method used by Oterhals and Samuelsen (2015). The principle is based on the measurement of change in height (sample volume) with respect to temperature increase (8° C./min) at constant pressure (100 bars). After Tₛmeasurement, the blank insert (no capillary opening) is replaced with a 1.75 mm capillary opening. The temperature is further increased at the same rate and a T_{f} defined as the temperature level initiating start of flow through the capillary die. The onset, endpoint and mean Tₛ were recorded at four (4) different moisture contents (10-20%).

Determination of molecular weight distribution of granulated plant protein and textured plant protein: Plant proteins are analyzed using Laemni conditions using a stain free Imaging technology approach with Mini-PROTEAN Tetra Cell and EZ ImageLab scanner .

Determination of hydrated hardness of textured plant protein (ISP Method): Extruded proteins were sieved using a size #8 US mesh. Samples that remained on top of sieve were retained for hardness testing. About 5 g of extruded proteins were weighed into a 150 ml plastic beaker. About 15 g of DI water was added to this beaker for a textured protein:water ratio of 1:3. The mixture was stirred for the first 1-2 minutes and left to hydrate for 5 min and 10 min. After hydration at specified times, the samples were transferred into a weighing boat and mixed by hand for about 1 min. Sample was then transferred to a 4 oz round aluminum container as show in the image and then evaluated on a texture analyzer. Hardness of the hydrated samples were measured using a compressive force using TA-11 probe, 5 kg load cell and 50% strain on a TA.XTPlus texture analyzer.

Determination of bulk density of textured plant protein (ISP Method): The textured proteins were sieved using a size #8 US mesh. Samples that remained on top of sieve was retained for bulk density measurements. Textured proteins that were not approximately 1 mm in size were broken up with hand to 1 mm size before weighing. A seedburo filling hopper and stand (SKU:V041.151) was used for bulk density measurements. The empty pint cup was placed on balance and then tared. The pint cup was then removed from balance and placed in hopper on stand. The pint cup was filled by pouring sample from top of the hopper. Once the cup was filled, the ruler was used to level the top. The cup was placed on the balance and then weighed. Samples were tested in duplicate. The weight of the textured proteins was calculated using the conversion: textured protein density (g/L)=textured protein weight (g)/jar volume (L) and 1 pint [US, dry]=about 0.551 liter.

Determination of water holding capacity (WHC) of textured plant protein (ISP Method): The textured proteins were sieved using a size #8 US mesh. All textured proteins that remained on top of sieve were retained for water holding capacity (WHC) measurements. Textured proteins were weighed into a weighting boat and the weight was recorded. The samples were poured into an 8 oz jar. DI water was weighed and added to the 8 oz jar containing the textured protein sample at room temperature for a textured protein:water ratio of 1:5. The weight of the water was recorded. The jar was tapped tightly, and textured protein hydrated for either 5 minutes or 10 minutes. The jar was flipped over after 5 minutes to ensure all textured protein pieces were soaked. After the set time (5 minutes or 10 minutes) a kitchen strainer was used to filter the soaked textured protein sample until no more water passed through the strainer. The wet textured proteins were weighed and recorded. A spoon was used to transfer the sample from the strainer to a weighting boat. The WHC was calculated using the equation:

$$\% WHC = ( \frac{weight of wet sample - weight of dry sample}{w eight of dry sample} ) * 100$$

Determination of sectional expansion index (SEI) of textured plant protein: The sectional expansion index (SEI) was determined as suggested by Alvarez-Martinez et al. (1988) and utilized by Beck et al. (2017). The SEI is the ratio between the cross-sectional area of the textured plant protein (Sₜₚₚ) and the cross-sectional area of the die (S_{d}). The diameter of the textured plant protein (Dₜₚₚ) was measured three times on ten samples, resulting in 30 measurements of the diameter, which is within the suggested size of 30 samples for a representative determination of the degree of expansion (Patil et al., 2007). The EI was calculated using the equation:

$$SEI = \frac{{S}_{t p p}}{{S}_{d}} = \frac{( π {D}_{t p p}^{2} * 0.25 )}{( π {D}_{d}^{2} * 0.25 )} = {( \frac{{D}_{t p p}}{{D}_{d}} )}^{2} = {( E I )}^{2}$$

1. An extrusion cooked vegetable protein composition comprising:
a. a legume protein from a single legume type in an amount of from an amount from about 60 to about 69%, by weight of the composition;
b. a carbohydrate in an amount from about 3% to about 9%; and
c. a fiber in an amount from about 3% to about 9%.
the composition having, when soaked in ambient temperature deionized water for 10 minutes:
i) a water holding capacity of from about 3.0 to about 4.5 g/g; and
ii) a firmness or from about 3200 g and 5400 g.

2. The composition of claim 1 further having a bulk density of from about 100 to 260 g/L.

3. The composition of claim 1 having an unhydrated moisture content of less than about 10% w/w.

4. The composition of claim 1 having a molecular weight distribution wherein at least 25% of the proteins in the composition have molecular weight of less than 10 kDa.

5. The composition of claim 1 having a molecular weight distribution wherein less than 30% of the composition is aggregates having a molecular weight greater than about 250 kDa.

6. A food composition comprising the extrusion cooked vegetable protein composition of claim 1 and a second edible ingredient.

7. A legume protein mixture comprising:
a. a first legume protein component in amount of from about 70% to about 90%; and
b. a second legume protein component in an amount of from about 10% to about 30% by weight of the composition
wherein the first and second legume protein components are from the same legume type and
wherein the mixture has a protein content from about 60 to about 69%, or by weight of the mixture.

8. (canceled)

9. The mixture of claim 7 further comprising a carbohydrate in an amount from about a carbohydrate in an amount from about 3% to about 9%.

10. The mixture of claim 7 wherein the second legume protein component is a native legume protein component.

11. The mixture of claim 7 wherein the protein has a denaturation enthalpy of 9 J/g or more.

12. The mixture of claim 7 wherein the first legume protein component has a denaturation enthalpy of less than 4 J/g.

13. The mixture of claim 7 having an onset phase transition temperature of (Tₛ) of about 15° C. to about 44° C.

14. The mixture of claim 7 having an endpoint phase transition temperature (Tₛ) of 42° C. to 110° C.

15. The mixture of claim 7 having a mean phase transition temperature (Tₛ) of about 31 to about 77.

16. (canceled)

17. A method of making an extrusion cooked vegetable protein composition comprising
a. obtaining a mixture of:
i. a first legume protein component in amount of from about 70% to about 90%; and
ii. a second legume protein component in an amount of from about 10% to about 30%;
b. feeding the mixture into an extruder; and
c. extruding the mixture using the extruder.
wherein the first and second legume protein components are the same from legume type.

18. The method of claim 17 wherein the extruding step comprises extruding the mixture using a specific mechanical energy of from about 250 to about 270 W*hr/kg.

19. (canceled)

20. (canceled)
